(19) United States
(12) Patent Application Publication
(10) Pub. No.: US 2009/0214918 A1
(43) Pub. Date: Aug. 27, 2009

(54) ANODE OF DIRECT METHANOL FUEL CELL AND DIRECT METHANOL FUEL CELL EMPLOYING THE SAME

(76) Inventors: Jungmin SONG, Kawasaki-Shi (JP); Yoshihiro Akasaka, Kawasaki-Shi (JP); Masato Akita, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/391,399

(22) Filed: Feb. 24, 2009

(30) Foreign Application Priority Data
Feb. 25, 2008 (JP) 2008-42833

(51) Int. Cl. H01M 8/10; H01M 4/86; H01M 4/88; B05D 5/12

(52) U.S. Cl. 429/30; 429/44; 427/115

(57) ABSTRACT

The present invention provides an anode used in a direct methanol fuel cell and a direct methanol fuel cell employing that anode. They can prevent crossovers of methanol and water and also can control permeation of water, so as to achieve high power output. The anode comprises an anode catalyst layer 20 and a gas-diffusion layer 150, and the gas-diffusion layer comprises a porous sheet support mainly made of carbon. In the porous sheet support, a high packing density area 50 is formed near the surface.

### CROSS-REFERENCE TO RELATED APPLICATION

This application is based upon and claims the benefit of priority from the prior Japanese Patent Application No. 42833/2008, filed on Feb. 25, 2008; the entire contents of which are incorporated herein by reference.

### BACKGROUND OF THE INVENTION

1. Field of the Invention

The present invention relates to a direct methanol fuel cell (hereinafter, often referred to as “DMFC”). In particular, the present invention relates to an electrode as a constituting component of the DMFC and also to a direct methanol fuel cell employing the same.

2. Background Art

A DMFC is a device in which methanol as a fuel is electrochemically oxidized to convert chemical energy of the fuel directly into electrical energy. Unlike thermal power generation, it provides electrical energy without firing the fuel to generate NOₓ and SOₓ. The fuel cell is, therefore, regarded as a clean source of electrical energy, and hence has attracted the attention of people.

The DMFC is required to have a structure in which the needs for feeding the fuel and for transporting generated products are both satisfied in good balance to improve the power output. For example, it is reported (for example, in JP-A 2001-283875 (KOKAI)) how a layer of water-repelling material such as fluororesin, silicone resin or polyethylene is formed on a fuel electrode or on an oxygen electrode.

Further, it is also disclosed (for example, in JP-A 2005-174607 (KOKAI)) to produce a polymer electrolyte membrane fuel cell having a structure in which both gas-permeability and moisture retentivity in a gas-diffusion electrode are ensured. Since the DMFC can be readily downsized and lightened as compared with a gas-fuel type polymer electrolyte membrane fuel cell (PEMFC) running on hydrogen fuel, it has been vigorously studied in these days to use the DMFC for application as an electric power supply source for cellular phones and notebook-size PCs.

The basic reactions in the DMFC are as follows:

anode: CH₃OH+H₂O->CO₂+6H⁺+6e⁻ (1)

cathode: ( 3/2)O₂+6H⁺+6e⁻->3H₂O (2).

As indicated in the formula (1), the reaction at the anode needs methanol and water. By the use of, for example, an alloy catalyst mainly comprising platinum and ruthenium, one methanol-molecule and one water-molecule are reacted to produce six protons and six electrons together with one waste carbon dioxide molecule. The produced electrons are led to an external electrical circuit, and thereby the electrical power can be outputted.

Also as indicated in the formula (2), the reaction at the cathode needs oxygen, protons and electrons. At the cathode, six electrons are reacted with 3/2 oxygen-molecules and six protons having been transported through a proton-conductive electrolyte membrane, to produce three waste water-molecules.

The methanol participating in the reaction at the anode sometimes permeates through the electrolyte membrane to the cathode side, and this phenomenon is called “methanol crossover”. The methanol crossover is known to impair performance of the DMFC cathode, and is hence regarded as a major cause to deteriorate performance of the fuel cell. Accordingly, for the purpose of improving the performance of DMFC, it is important to reduce the methanol crossover. Meanwhile, water must be supplied together with methanol to the anode side, so as to ensure ion-conductivity of electrolyte in the electrolyte membrane and in the electrode. However, if excess water flows into the cathode side, troubles such as flooding at the cathode are often caused. Accordingly, it is practically important to control drainage of water from an outlet on the cathode side. In view of this, it is also important to prevent the excess water from flowing out of the anode side into the cathode side.

Hitherto, a gas-diffusion electrode has been studied as an electrode of PEMFC so as to improve the drainage of water from the electrode and to ensure the diffusion of reactive gas. As a result of that, the electrode used now is generally combined with a gas-diffusion intermediate layer made of, for example, carbon paper or carbon cloth coated with slurry obtained by mixing hydrophobic fluorinated polymer and powdery carbon.

In order to improve diffusion of gas in the intermediate layer, it is proposed (for example, in JP-A 2001-85019) to form the gas-diffusion intermediate layer by the use of a novel technology in which the slurry obtained by mixing fluorinated polymer and powdery carbon is prevented from soaking into the carbonaceous support.

Unlike the PEMFC, the DMFC runs on liquid methanol fuel supplied to its anode. Accordingly, the electrode of DMFC must be designed to have functions by which the methanol crossover can be avoided and by which water more than needed to keep conductivity of the electrolyte can be prevented from flowing into the cathode side.

On the other hand, however, in order to obtain high power output from the DMFC, it is also necessary to supply the anode catalyst layer with a sufficient amount of methanol. Accordingly, the DMFC preferably has a structure capable not only of preventing the crossovers of excess methanol and water but also of ensuring that methanol necessary for the electrode reaction can diffuse in the anode-gas diffusion layer.

The conventional DMFC suffers from large methanol crossover, and a considerable amount of water is drained in practice although not indicated in the formula (1). This is known to be caused by proton migration and diffusion of water from the anode side to the cathode side.

As described above, for the purpose of improving the power output, the fuel cell is needed to have a structure capable of preventing water from flowing out and of avoiding the methanol crossover and the crossover of excess water.

JP-A 2001-203875 (KOKAI) or JP-A 2005-174607 (KOKAI), for example, discloses a water-repelling material-containing layer having functions of supplying reactive gas to the catalyst layer, of evacuating produced gas, and particularly, of controlling drainage of water having collected on the cathode side.

Nevertheless, the conventional electrode structure still suffers from large methanol crossover, insufficiently prevents water from permeating, and cannot satisfyingly drain water having collected on the cathode side, and consequently, the flow of oxygen gas to be supplied to the cathode is often stagnated. Accordingly, there is room for improvement to ensure that the fuel cell can work stably for a long time.

### SUMMARY OF THE INVENTION

The present invention resides in an anode used in a direct methanol fuel cell, comprising an anode catalyst layer and a gas-diffusion layer; wherein said gas-diffusion layer comprises a porous sheet support mainly made of carbon, said porous sheet support includes a high packing density area having a higher packing density than said porous sheet support by 15% or more, and said high packing density area is formed in said porous sheet support in a depth range of 50 to 200 μm from at least one of the surfaces.

The present invention also resides in a process for formation of an anode-side gas-diffusion layer used in a direct methanol fuel cell; wherein slurry containing water-repelling material and electrically conductive material is cast on at least one of the surfaces of a porous sheet support while said slurry is being applied with pressure to soak into said porous sheet support, so that a high packing density area having a higher packing density than said porous sheet support by 15% or more is formed in said porous sheet support in a depth range of 50 to 200 μm from the surface.

The present invention still also resides in a membrane electrode assembly comprising an anode-side porous gas-diffusion layer, an anode catalyst layer, a proton-conductive membrane, a cathode catalyst layer and a cathode-side gas-diffusion layer, stacked in this order; wherein said anode-side porous gas-diffusion layer comprises a porous sheet support mainly made of carbon, said porous sheet support includes a high packing density area having a higher packing density than said porous sheet support by 15% or more, and said high packing density area is formed in said porous sheet support in a depth range of 50 to 200 μm from at least one of the surfaces.

The present invention further resides a direct methanol fuel cell comprising an electrolyte membrane, an anode and a cathode; wherein said anode comprises an anode catalyst layer and a gas-diffusion layer, said gas-diffusion layer comprises a porous sheet support mainly made of carbon, said porous sheet support includes a high packing density area having a higher packing density than said porous sheet support by 15% or more, and said high packing density area is formed in said porous sheet support in a depth range of 50 to 200 μm from at least one of the surfaces.

In the present invention, the crossovers of methanol and water from the anode side to the cathode side are inhibited so as to avoid voltage depression at the cathode, to prevent water from collecting and to ensure sufficient power output of the fuel cell without obstructing the oxygen supply to the cathode. The present invention thus provides a DMFC having long-term stability for working as a fuel cell.

### BRIEF DESCRIPTION OF THE DRAWINGS

FIG. 1 is a schematic cross-sectional view showing a structure of a direct methanol fuel cell according to one embodiment of the present invention.

FIG. 2 shows schematic cross-sectional views of anodes usable in a direct methanol fuel cell according to one embodiment of the present invention.

FIG. 3 schematically shows a process for formation of a gas-diffusion intermediate layer used in a direct methanol fuel cell according to one embodiment of the present invention.

FIG. 4 is a graph schematically illustrating distribution of packing density in a gas-diffusion layer.

FIG. 5 is a graph showing voltage characteristics of Example 1 and Comparative Example 1.

### DETAILED DESCRIPTION OF THE INVENTION

Embodiments of the present invention are explained below with the attached drawings referred to. In the following drawings, the same numbers are given to the same parts and the illustrations for the same parts are not repeated. All the drawings are schematic views, and hence the figured dimensional relations such as the relation between the thickness and the plane dimensions and the ratio among the layers are different from the actual ones. Further, even if the same parts are figured in different drawings, their figured dimensional relations are not always the same.

First, the direct methanol fuel cell (DMFC) is explained below. The direct methanol fuel cell comprises a membrane electrode assembly (hereinafter, often referred to as “MEA”), which is an electromotive element of the fuel cell. Generally, the MEA comprises an anode current collector, an anode catalyst layer, a proton-conductive membrane (or an electrolyte membrane), a cathode catalyst layer, and a cathode current collector, stacked in this order. Each current collector is generally made of porous electrically conductive material, and has an additional function of supplying liquid fuel or oxidant gas to the catalyst layer. The current collector is, therefore, often referred as a fuel- or gas-diffusion layer (hereinafter, often referred to as “diffusion layer”).

Each catalyst layer may comprise a porous layer containing, for example, catalytic active material, electrically conductive material and proton-conductive material. In the case where the electrically conductive material serves as carrier of supported catalyst, the catalyst layer comprises a porous layer containing the supported catalyst and proton-conductive material.

A combination of the diffusion layer and the catalyst layer is referred to as an “electrode”. The combination of the anode diffusion layer and the anode catalyst layer is referred to as a “fuel electrode” while that of the cathode diffusion layer and the cathode catalyst layer is referred to as an “oxidant electrode (oxygen electrode)”. (Hereinafter, they are often referred to as a “fuel electrode” and an “oxidant electrode”, respectively.)

When a methanol/water mixed fuel and air (oxygen) are supplied to the anode catalyst layer and the cathode catalyst layer, respectively, the aforementioned catalytic reactions represented by the formulas (1) and (2) are started in the catalyst layers of the electrodes. The catalyst layers are, therefore, often referred to as “reaction layers”.

At the anode, methanol and water are reacted to produce carbon dioxide, protons and electrons. The protons permeate through the electrolyte membrane into the cathode side. At the cathode, oxygen, the protons and electrons having transferred from the anode through an external electrical circuit are combined to produce water.

In a DMFC, a mixture of methanol and water in the liquid state (methanol aqueous solution) is supplied from a liquid fuel reservoir to the catalyst layer of the fuel electrode, and thereby protons (H⁺), electrons (e−) and carbon dioxide are produced on the catalyst (see, the formula (1)). The produced protons permeate through the polymer electrolyte membrane into the cathode side, and are reacted with oxygen on the catalyst layer of the oxidant electrode to produce water. Since the external electrical circuit is connected between the fuel electrode and the oxidant electrode, the produced electrons are led to the circuit to obtain electrical power. The produced water is drained out from the air electrode side. On the other hand, in the case where the liquid fuel is directly supplied to the cell, the waste carbon dioxide produced on the fuel electrode side is diffused in the liquid fuel phase and then is excreted out of the fuel cell via a gas-permeable membrane, which allows only the gas to pass through.

In order to obtain excellent properties of the above fuel cell, it is required that an adequate amount of fuel be smoothly supplied, that the electrode catalytic reactions be made to proceed rapidly at the three-phase interface among the catalytic active material, the proton-conductive material and the fuel, that the electrons and the protons be transferred smoothly, and that the reaction products be rapidly excreted.

Practical embodiments of the present invention are explained below with the attached drawings referred to. In the following drawings, the same numbers are given to the same parts and the illustrations for the same parts are not repeated. All the drawings are schematic views, and hence the figured dimensional relations such as the relation between the thickness and the plane dimensions and the ratio among the layers are different from the actual ones. Further, even if the same parts are figured in different drawings, their figured dimensional relations are not always the same.

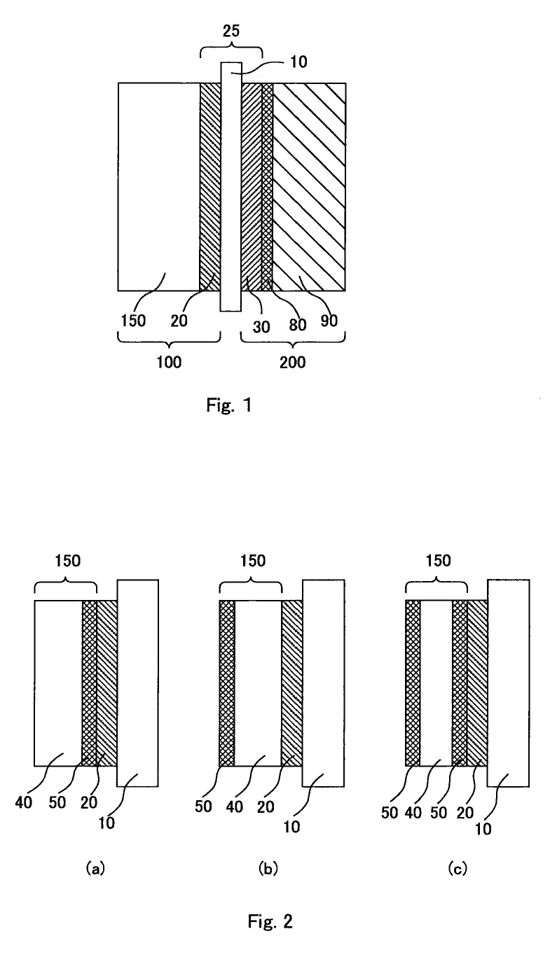

FIG. 1 is a schematic cross-sectional view of a DMFC according to the present invention. The DMFC of the present invention comprises an electrolyte membrane 10, an anode catalyst layer 20 provided on the surface of the electrolyte membrane 10 on the anode side 100, and a cathode catalyst layer 30 provided on the surface of the electrolyte membrane 10 on the cathode side 200.

The electrolyte membrane 10 is prepared, for example, by cutting a commercially available perfluorocarbonsulfonic acid membrane (e.g., Nafion 112 [trademark], available from DuPont Co., Ltd.) into a piece of approx. 40 mm×50 mm, and then subjecting the piece to a known pretreatment with hydrogen peroxide and sulfuric acid (see., G. Q. Lu et al., Electrochemica Acta 49 (2004), 821-828).

The anode catalyst layer 20 mainly promotes the reaction of methanol and water into protons, electrons and carbon dioxide, and is formed, for example, by mixing a Pt/Ru alloy catalyst (e.g., Pt/Ru Black HiSPEC 6000 [trademark], available from Johnson & Matthey) and a perfluorocarbonsulfonic acid solution (e.g., a solution of 5 wt. % Nafion [trademark], available from DuPont Co., Ltd.; SE-29992 [trademark], available from Aldrich), and then casting the mixture onto a PTFE base sheet. The thus prepared anode catalyst layer 20 after dried contains the PtRu alloy in an amount (hereinafter, referred to as “loading amount”) of, for example, approx. 6 mg/cm².

The cathode catalyst layer 30 mainly promotes the reaction of protons, electrons and oxygen into water, and is formed, for example, by mixing a Pt/C catalyst (e.g., HP 40 wt.% Pton Vulcan XC-72R [trademark], available from E-TEK) and a perfluorocarbonsulfonic acid solution (e.g., a solution of 5 wt.% Nafion [trademark], available from DuPont Co., Ltd.; SE-20092 [trademark], available from Aldrich), and casting the mixture onto a PTFE base sheet. The thus prepared cathode catalyst layer 30 after dried contains Pt in a loading amount of, for example, approx. 2.6 mg/cm².

The anode and cathode catalyst layers 20 and 30 formed on the PTFE sheets are individually cut together with the PTFE base sheets into pieces of approx. 30 mm×40 mm. The electrolyte membrane 10 is inserted between the sized anode and cathode catalyst layers 20 and 30, and then they are hot-pressed at 125° C. and 10 kg/cm² for approx. 3 minutes to unify the electrolyte membrane 10, the anode catalyst layer 20 and the cathode catalyst layer 30. (Hereinafter, the layered element consisting of the electrolyte membrane, the anode catalyst layer and the cathode catalyst layer is often referred to as a “catalyst coated membrane” or “CCM”.)

The PTFE base sheets are then removed from the layered product produced above to obtain a CCM 25 having a thickness of, for example, approx. 90 μm. In that CCM, the anode and cathode catalyst layers 20 and 30 have thicknesses of approx. 30 μm and approx. 30 μm, respectively.

On the anode catalyst layer 20-side of the CCM 25, an anode-side porous gas-diffusion layer (hereinafter, often referred to as an “anode GDL”) 150 including a gas-diffusion intermediate layer (hereinafter, often referred to as a “MPL”) is provided. In the present invention, a MPL 50 is provided on at least one surface of the anode GDL 150. As shown in FIG. 2 (a) to (c), the MPL 50 can be placed on the catalyst layer side (FIG. 2 (a)), on the side opposite to the catalyst layer (FIG. 2 (b)) or on both sides (FIG. 2 (c)) of the GDL 40. As described later, the MPL has a higher packing density than the porous sheet support 40, and hence can be referred to as a “high packing density area”.

On the cathode catalyst layer 30-side of the CCM 25, a cathode GDL (cathode porous gas-diffusion layer) 90 is provided. Further, a cathode water-repelling layer (hereinafter, often referred to as a “cathode MPL”) 80 is placed between the cathode catalyst layer 30 and the cathode GDL 90. A commercially available cathode GDL combined with a MPL (e.g., Flat GDL LT-2500-W [trademark], available from E-TEK; thickness: approx. 360 μm), in which the cathode MPL 80 is formed on the cathode GDL 90, is favorably employed.

Although not shown in the drawings, a fuel feeding means for supplying the liquid fuel (methanol) is also provided so that it faces onto the GDL 150 including the anode MPL. The concentration of the methanol fuel is in the range of preferably 0.5 to 3 M, more preferably 0.5 to 2.0 M. Further, although not shown in the drawings, an oxidant gas feeding means for supplying the oxidant gas (air) is provided on the cathode GDL 90 on the side opposite to the cathode MPL 80.

The anode GDL base 40 is not particularly restricted as long as it is a porous sheet support mainly made of carbon. Such sheet support is generally used as an element of the gas-diffusion layer in a known fuel cell. The support is normally a porous substrate containing fibers, which are preferably electrically conductive and anti-corrosive carbon fibers but not restricted to them. For example, the support is a sheet of carbon paper TGPH-120 ([trademark], available from Toray Industries Inc.) subjected to water-repelling treatment with 30% PTFE, namely, a sheet of 30% wetproofed TGPH-120 ([trademark], available from E-TEK, New Jersey, U.S.). The sheet support has a thickness of 200 μm or more, preferably 250 μm or more, so as to inhibit the methanol crossover. On the other hand, the thickness of the support is preferably 500 μm or less, preferably 400 μm or less, so as to keep good fundamental properties of the fuel cell.

The gas-diffusion intermediate layer (MPL) 50 is normally formed from slurry containing water-repelling material and electrically conductive material. Preferred examples of the water-repelling material include water-repelling organic synthetic resins such as polytetrafluoroethylene (PTFE), tetra-fluoroethylene-perfluoroalkylvinylether copolymer (PFA), tetra-fluoroethylene-hexafluoropropylene copolymer (FEP), poly-chlorotrifluoroethylene (PCTFE), polyvinylidene fluoride (PVDF), polyvinyl fluoride (PVF) and tetrafuloroethylene-ethylene copolymer (ETFE). As the electrically conductive material, electrically conductive carbon is preferred. Examples of the electrically conductive carbon include furnace black, acetylene black and graphite black.

The GDL including the anode MPL in the present invention is characterized in that the packing density at the surface of GDL is higher than that of the sheet support, namely, than that of the GDL base. For producing that characteristic structure, the slurry of MPL is made to soak at least partly into the support in forming the MPL on the support of GDL.

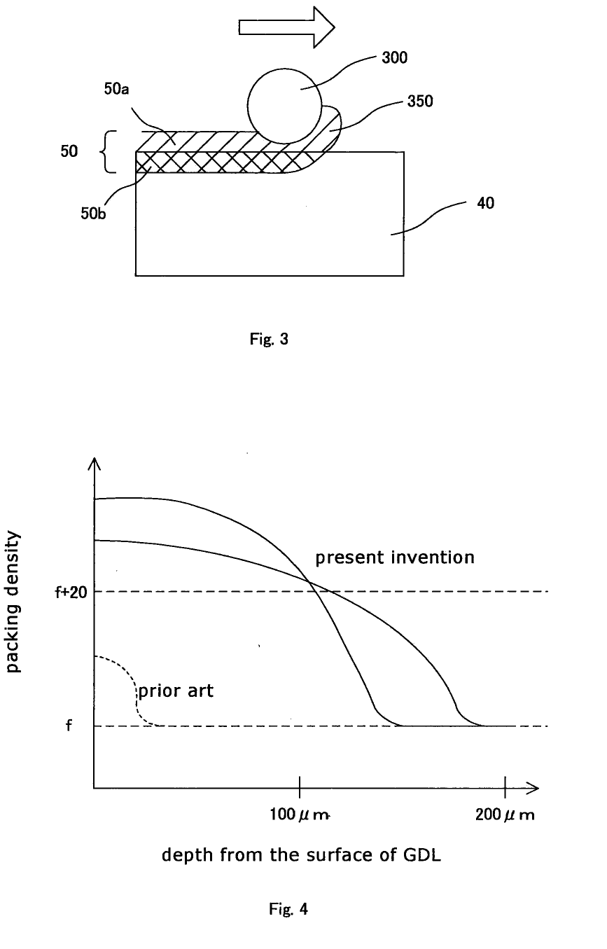

For example, the slurry containing the materials of MPL is cast on the sheet support while applied with pressure, to form the MPL having the above characteristic structure. FIG. 3 shows one embodiment of the process for forming MPL. In casting the slurry 350 on the sheet support 40, a high pressure is applied by the bar 300 and thereby a part 50b of the formed MPL is soaked into the sheet support. As a result, the formed MPL consists of the part 50a spread on the surface of the sheet support and the part 50b soaked therein. The area impregnated with 50b in the support 40 has a high packing density, and hence is a high packing density area.

In the present invention, the area impregnated with 50b is indispensable while the part 50a on the surface of the support is not. Accordingly, the MPL may consist of only the part 50b soaked in the support 40.

The MPL having that structure may be formed by other methods. For example, the bar 300 can be replaced with a blade or the like. Further, after the MPL 50a is formed on the support in a desired manner, the pressure may be applied so as to soak the slurry into the support. In the case where the bar or blade is used, the gap between the support and the bar or the blade is preferably set at 0 so that the support is kept in contact with the bar or the blade while the slurry is being cast.

In a conventional process for forming the MPL, the slurry in a relatively low concentration has been used in consideration of coatability since it is aimed only to place the MPL on the surface of the support. In contrast, however, it is preferred in the present invention to use the slurry in a considerably high concentration so that the area impregnated with MPL can have a high packing density. The slurry practically comprises the water-repelling material and the conductive material dissolved or dispersed in a solvent, and the solid content thereof is preferably 40 wt. % or more. Thus, the slurry of the present invention has a higher solid content than the conventional slurry, which has a solid content of 5 to 20 wt. %.

In the above manner, the MPL soaked in the porous sheet support has a higher packing density than the sheet support. The packing density of MPL soaked in the support changes in the thickness direction, but is highest generally at the surface of the initial support 40. This means that it is highest at the interface between the surface of the support and the MPL membrane formed thereon in the case where the part 50a of MPL is provided on the surface of the support 40 or otherwise at the surface of the support in the case where all the MPL is soaked in the support. The packing density of the impregnated area, namely, of the high packing density area is higher than that of the sheet support by 15% or more, preferably by 18% or more.

The MPL in the present invention is soaked into the sheet support more deeply than the conventional MPL simply formed on the support. In the present invention, the porous sheet support has a thickness of generally 200 μm or more, preferably 250 μm or more so as to prevent the methanol crossover. For further preventing the crossovers of methanol and water, the high packing density area has a thickness of 50 μm or more, preferably 80 μm or more. On the other hand, since the area having a low packing density often improves power-generation efficiency, the high packing density area has a thickness of 200 μm or less, preferably 180 μm or less. In other words, the packing density in a depth range of 10 μm from the surface of the porous sheet support is preferably 15% or more, more preferably 18% or more, higher than that of the porous sheet support in which the high packing density area is yet to be formed.

FIG. 4 is a graph schematically illustrating the above distribution of packing density. The broken lines in FIG. 4 represent the packing densities of conventional MPL. Since the conventional MPL is simply placed on the support, it hardly soaks into the support in the thickness direction and hence the packing density thereof even at the highest is lower than that of the MPL according to the present invention and also the area having a relatively high packing density ranges in a shallow depth. In contrast, however, the MPL of the present invention has a remarkably high packing density at the surface of the support (i.e., GDL) and soaks so deeply that the area having a high packing density is formed in a large thickness.

In the present invention, the area impregnated with MPL has a high packing density. This means that pores in that area of the sheet support are filled with the material of MPL. Accordingly, those pores have small porous diameters and the porous volume in that area is relatively low. The porous sheet support in which the high packing density area is yet to be formed has an average porous diameter of generally 10 to 100 μm, preferably 20 to 50 μm. In contrast, however, the average porous diameter in the high packing density area is in the range of 0.1 to 10%, preferably 0.5 to 5% of the above. Accordingly, the high packing density area has an average porous diameter of preferably 10 μm or less, more preferably 5 μm or less.

Also in the present invention, the porous sheet support in which the high packing density area is yet to be formed has a porous volume of generally 50 to 80%, preferably 60 to 75%. In contrast, however, the porous volume in the high packing density area is in the range of 20 to 80%, preferably 30 to 60% of the above. Accordingly, the high packing density area has a porous volume of preferably 65% or less, more preferably 60% or less. Here, the average porous diameter and the porous volume can be measured according to the mercury porosimeter method.

The anode-side gas-diffusion layer described above can be employed in a generally used MEA. The MEA generally comprises an anode-side porous gas-diffusion layer (anode current collector), an anode catalyst layer, a proton-conductive membrane (or electrolyte membrane), a cathode catalyst layer, and a cathode-side porous gas-diffusion layer (cathode current collector), stacked in this order. The above anode GDL can be used as the anode-side porous gas-diffusion layer, and the MEA employing the anode GDL can be used as an electromotive element of direct methanol fuel cell.

In the DMFC according to the present invention, the aforementioned anode GDL and MPL are employed and thereby the crossovers of methanol and water can be prevented to ensure sufficient power output. Thus, the fuel cell according to the present invention can keep outputting high electrical power.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

### Example 1

The DMFC produced in this example comprised an anode having a cross-sectional view shown in FIG. 1. First, the anode was prepared in the following manner.

Onto both surfaces of a carbonaceous support of carbon paper (thickness: 400 μm, packing density: 10%, average porous diameter: 25 μm, porous volume: 65%) having been subjected to 30 wt. % water-repelling treatment, slurry (solid content: 25%) containing a mixture of water-repelling fluororesin and water-repelling carbon material was cast with a bar while applied with pressure. In the casting procedure, the gap between the sheet support and the bar was set at 0. Thus, a gas-diffusion intermediate layer was formed inside the support on each side (FIG. 2(c)). The gas-diffusion intermediate layer after subjected to hot-press was soaked in a depth range of 150 μm from each surface of the carbon paper. The highest packing density in that area was higher than that of the support by 20%. The average porous diameter and porous volume in that area were 0.5 μm and 55%, respectively. As the cathode side gas-diffusion layer, carbon cloth provided with a gas-diffusion layer was used. Cathode and anode catalyst layers were individually formed by the transferring method, and each layer was brought into contact with each of the above gas-diffusion layers. The layers were then combined to obtain a membrane electrode assembly (MEA).

The obtained MEA was installed in a DMFC having the structure explained in the above embodiment, and subjected to the following power generation test. The fuel cell was worked while a fuel (1.4 M methanol aqueous solution fuel) in an amount of 0.7 cc/minute and air (oxidant, oxygen content: 20.5%, humidity: 30%) in an amount of 60 cc/minute were supplied to the anode GDL and the cathode GDL, respectively. The outputted power was measured, and thereby the characteristics of the fuel cell were evaluated.

In the measurement, the temperature was controlled so that thermo sensors mounted on the fuel feeding means and on the oxidant feeding means might both indicate 60° C., and the air and the fuel were not preheated.

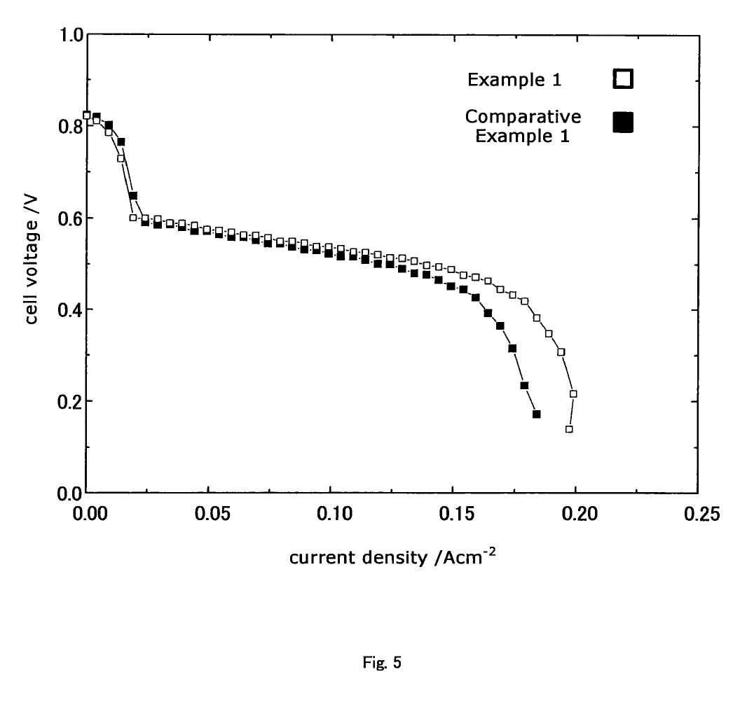

The methanol crossover, the α (water permeability) value and the characteristic voltage at 150 mA/cm² were measured under the above working conditions, and the results were as set forth in Table 1. Also, the current-voltage characteristics were measured and shown in FIG. 5.

As set forth in Table 1, it was confirmed that the methanol crossover, the avalue and the characteristic voltage at 150 mA/cm² were 22%, 0.04 and 0.49 V, respectively. As shown in FIG. 5, the produced fuel cell exhibited higher characteristic voltages than that of Comparative Example 1 did. The methanol crossover and the a value were both very low, and the water permeability was also confirmed to be small.

### Example 2

The procedure of Example 1 was repeated except that the gas-diffusion intermediate layer was formed on only one surface of the sheet support (FIG. 2(a)). The gas-diffusion intermediate layer after subjected to hot-press was soaked in a depth range of 150 μm from the surface of the support. The highest packing density in that area was higher than that of the support by 23%. The average porous diameter and porous volume in that area were 0.5 μm and 55%, respectively. As the cathode side gas-diffusion layer, carbon cloth provided with a gas-diffusion layer was used. Cathode and anode catalyst layers were individually formed by the transferring method, and the anode catalyst layer was brought into contact with the anode gas-diffusion intermediate layer. The layers were then combined to obtain a unified assembly.

The obtained assembly was installed in a DMFC having the structure explained in the above embodiment, and subjected to the following power generation test. The fuel cell was worked while a fuel (1.2 M methanol aqueous solution fuel) in an amount of 0.7 cc/minute and air (oxidant, oxygen content: 20.5%, humidity: 30%) in an amount of 60 cc/minute were supplied to the anode GDL and the cathode GDL, respectively. The outputted power was measured, and thereby the characteristic of the fuel cell was evaluated.

In the measurement, the temperature was controlled so that thermo sensors mounted on the fuel feeding means and on the oxidant feeding means might both indicate 60° C., and the air and the fuel were not preheated.

The methanol crossover, the α (water permeability) value and the characteristic voltage at 150 mA/cm² were measured under the above working conditions, and the results were as set forth in Table 1. The current-voltage characteristics were also measured and compared with those of Example 1 shown in FIG. 5.

As set forth in Table 1, it was confirmed that the methanol crossover, the α value and the characteristic voltage at 150 mA/cm² were 20%, 0.07 and 0.48 V, respectively. The produced fuel cell exhibited higher characteristic voltages than that of Comparative Example 1 did as shown in FIG. 5. The methanol crossover and the a value were both very low, and the water permeability was also confirmed to be small.

### Example 3

The procedure of Example 2 was repeated to form a gas-diffusion intermediate layer on only one surface of the sheet support. On the gas-diffusion intermediate layer thus formed, another gas-diffusion intermediate layer was further formed by casting. In the casting procedure, the gap between the sheet support and the bar was set at 100 μm. The gas-diffusion intermediate layer thus formed on the surface of the support had a thickness of 20 μm or less after subjected to hot-press. As the cathode side gas-diffusion layer, carbon cloth provided with a gas-diffusion layer was used. Cathode and anode catalyst layers were individually formed by the transferring method, and the anode catalyst layer was brought into contact with the anode gas-diffusion intermediate layer. The layers were then combined to obtain a unified assembly.

The obtained assembly was installed in a DMFC having the structure explained in the above embodiment, and subjected to the following power generation test. The fuel cell was worked while a fuel (1.2 M methanol aqueous solution fuel) in an amount of 0.7 cc/minute and air (oxidant, oxygen content: 20.5%, humidity: 30%) in an amount of 60 cc/minute were supplied to the anode GDL and the cathode GDL, respectively. The outputted power was measured, and thereby the characteristic of the fuel cell was evaluated.

In the measurement, the temperature was controlled so that thermo sensors mounted on the fuel feeding means and on the oxidant feeding means might both indicate 60° C., and the air and the fuel were not preheated.

The methanol crossover, the α (water permeability) value and the characteristic voltage at 150 mA/cm² were measured under the above working conditions, and the results were as set forth in Table 1. It was confirmed that the methanol crossover, the a value and the characteristic voltage at 150 mA/cm² were 22%, 0.08 and 0.46 V, respectively. The produced fuel cell exhibited higher characteristic voltages than that of Comparative Example 1 did as shown in FIG. 5. The methanol crossover and the α value were both very low, and the water permeability was also confirmed to be small.

### Comparative Example 1

Onto both surfaces of a carbonaceous support of carbon paper (thickness: 400 μm) having been subjected to 30 wt. % water-repelling treatment, slurry containing a mixture of water-repelling fluororesin and water-repelling carbon material was cast with a bar. In the casting procedure, the gap between the sheet support and the bar was set at 200 μm. Thus, a gas-diffusion intermediate layer was formed on the surface of the support on each side. The gas-diffusion intermediate layers thus formed, namely, water-repelling layers scarcely soaked into the carbon paper. Each water-repelling layer formed on the surface of the support had a thickness of 30 μm after subjected to hot-press. As the cathode side gas-diffusion layer, carbon cloth provided with a gas-diffusion layer was used. Cathode and anode catalyst layers were individually formed by the transferring method, and each layer was brought into contact with each of the above gas-diffusion layers. The layers were then combined to obtain a unified assembly.

The obtained assembly was installed in a DMFC having the structure explained in the above embodiment, and subjected to the following power generation test. The fuel cell was worked while a fuel (1.2 M methanol aqueous solution fuel) in an amount of 0.7 cc/minute and air (oxidant, oxygen content: 20.5%, humidity: 30%) in an amount of 60 cc/minute were supplied to the anode GDL and the cathode GDL, respectively. The outputted power was measured, and thereby the characteristic of the fuel cell was evaluated.

In the measurement, the temperature was controlled so that thermo sensors mounted on the fuel feeding means and on the oxidant feeding means might both indicate 60° C., and the air and the fuel were not preheated.

The methanol crossover, the α (water permeability) value and the characteristic voltage at 150 mA/cm² were measured under the above working conditions, and the results were as set forth in Table 1. It was confirmed that the methanol crossover, the a value and the characteristic voltage at 150 mA/cm² were 35%, 0.32 and 0.44 V, respectively. As shown in FIG. 5, the produced fuel cell exhibited lower characteristic voltages than that of Example 1 did. The methanol crossover and the α value were both relatively high.

### Comparative Example 2

Onto both surfaces of a carbonaceous support of carbon paper (thickness: 190 μm) having been subjected to 30 wt. % water-repelling treatment, slurry containing a mixture of water-repelling fluororesin and water-repelling carbon material was cast with a bar while applied with pressure. In the casting procedure, the gap between the sheet support and the bar was set at 0. Thus, a gas-diffusion intermediate layer, namely, a water-repelling carbon layer was formed inside the support on each side. The water-repelling carbon layer after subjected to hot-press was soaked in a depth range of 10 μm or less from each surface of the carbon paper. The highest packing density in that area was higher than that of the support by 18%. The average porous diameter and porous volume in that area were 0.6 μm and 66%, respectively. As the cathode side gas-diffusion layer, carbon cloth provided with a gas-diffusion layer was used. Cathode and anode catalyst layers were individually formed by the transferring method, and each layer was brought into contact with each of the above gas-diffusion layers. The layers were then combined to obtain a unified assembly.

The obtained assembly was installed in a DMFC having the structure explained in the above embodiment, and subjected to the following power generation test. The fuel cell was worked while a fuel (1.2 M methanol aqueous solution fuel) in an amount of 0.7 cc/minute and air (oxidant, oxygen content: 20.5%, humidity: 30%) in an amount of 60 cc/minute were supplied to the anode GDL and the cathode GDL, respectively. The outputted power was measured, and thereby the characteristic of the fuel cell was evaluated.

In the measurement, the temperature was controlled so that thermo sensors mounted on the fuel feeding means and on the oxidant feeding means might both indicate 60° C., and the air and the fuel were not preheated.

The methanol crossover, the α (water permeability) value and the characteristic voltage at 150 mA/cm² were measured under the above working conditions, and the results were as set forth in Table 1. It was confirmed that the methanol crossover, the α value and the characteristic voltage at 150 mA/cm² were 42%, 0.12 and 0.43 V, respectively. They were a low voltage, a high methanol crossover and a high α value, as compared with the results of the examples employing carbon paper of 400 μm thickness.

TABLE 1

| | Concentration | Methanol | | |
|---|---|---|---|---|
| | of methanol | crossover | Water | Cell voltage |
| | (M) | (%) | permeability α | (V) |
| Ex. 1 | 1.4 | 22 | 0.04 | 0.49 |
| Ex. 2 | 1.2 | 20 | 0.70 | 0.48 |
| Ex. 3 | 1.2 | 22 | 0.80 | 0.46 |
| Com. 1 | 1.2 | 35 | 0.32 | 0.44 |
| Com. 2 | 1.2 | 42 | 0.12 | 0.43 |

1. An anode used in a direct methanol fuel cell, comprising an anode catalyst layer and a gas-diffusion layer; wherein said gas-diffusion layer comprises a porous sheet support mainly made of carbon, said porous sheet support includes a high packing density area having a higher packing density than said porous sheet support by 15% or more, and said high packing density area is formed in said porous sheet support in a depth range of 50 to 200 μm from at least one of the surfaces.

2. The anode according to claim 1, wherein said porous sheet support has a thickness of 200 to 500 μm.

3. The anode according to claim 1, wherein said high packing density area has a thickness of 50 to 200 μm.

4. The anode according to claim 1, wherein said porous sheet support has an average porous diameter of 10 to 100 μm but said high packing density area has an average porous diameter in the range of 0.1 to 10% based on the average porous diameter of said porous sheet support.

5. The anode according to claim 1, wherein said high packing density area has an average porous diameter in the range of 0.01 to 10 μm.

6. The anode according to claim 1, wherein said porous sheet support has a porous volume ratio of 50 to 80% but said high packing density area has a porous volume ratio in the range of 20 to 80% based on the porous volume ratio of said porous sheet support.

7. The anode according to claim 1, wherein said high packing density area has a porous volume ratio in the range of 25 to 65%.

8. The anode according to claim 1, wherein the packing density of said porous sheet support in a depth range of 100 μm from the surface is 15% or more higher than that of the porous sheet support in which said high packing density area is yet to be formed.

9. A process for formation of an anode-side gas-diffusion layer used in a direct methanol fuel cell; wherein slurry containing water-repelling material and electrically conductive material is cast on at least one of the surfaces of a porous sheet support while said slurry is being applied with pressure to soak into said porous sheet support, so that a high packing density area having a higher packing density than said porous sheet support by 15% or more is formed in said porous sheet support in a depth range of 50 to 200 μm from the surface.

10. The process according to claim 9 for formation of an anode-side gas-diffusion layer used in a direct methanol fuel cell; wherein said slurry is cast by a bar or a blade under the condition that the gap between said porous sheet support and said bar or said blade is set at 0.

11. The process according to claim 9 for formation of an anode-side gas-diffusion layer used in a direct methanol fuel cell; wherein the solid content of said slurry is in the range of 20 to 50%.

12. The process according to claim 9 for formation of an anode-side gas-diffusion layer used in a direct methanol fuel cell; wherein said water-repelling material is a water-repelling organic synthetic resin.

13. The process according to claim 9 for formation of an anode-side gas-diffusion layer used in a direct methanol fuel cell; wherein said electrically conductive material is electrically conductive carbon.

14. A membrane electrode assembly comprising an anode-side porous gas-diffusion layer, an anode catalyst layer, a proton-conductive membrane, a cathode catalyst layer and a cathode-side gas-diffusion layer, stacked in this order; wherein said anode-side porous gas-diffusion layer comprises a porous sheet support mainly made of carbon, said porous sheet support includes a high packing density area having a higher packing density than said porous sheet support by 15% or more, and said high packing density area is formed in said porous sheet support in a depth range of 50 to 200 μm from at least one of the surfaces.

15. A direct methanol fuel cell comprising an electrolyte membrane, an anode and a cathode; wherein said anode comprises an anode catalyst layer and a gas-diffusion layer, said gas-diffusion layer comprises a porous sheet support mainly made of carbon, said porous sheet support includes a high packing density area having a higher packing density than said porous sheet support by 15% or more, and said high packing density area is formed in said porous sheet support in a depth range of 50 to 200 μm from at least one of the surfaces.

16. The direct methanol fuel cell according to claim 15, employing a 0.5 to 3 M methanol as a fuel.
